(19) United States
(12) Patent Application Publication
(10) Pub. No.: US 2005/0149454 A1
(43) Pub. Date: Jul. 7, 2005

(54) Device and method for digital certificate distribution

(76) Inventors: GiGi Chen, Taipei City (TW); Chien Yuan Pien, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/747,280

(22) Filed: Dec. 30, 2003

(51) Int. Cl. G06F 17/60

(52) U.S. Cl. 705/64

(57) ABSTRACT

The present invention discloses a device and a method for digital certificate distribution. The device comprises at least an digital certificate receiver for receiving and storing at least an digital certificate, a display being provided on the digital certificate receiver for displaying the digital certificate; an digital certificate transmitter for transmitting the digital certificate to the digital certificate receiver by using a telecommunication device; and an digital certificate reader for reading the digital certificate displayed on the display on the digital certificate receiver. The method comprises steps of: encoding shopping information into an digital certificate prior to being transmitted by using an digital certificate transmitter, and then the digital certificate being transmitted to an digital certificate receiver by using a telecommunication device; receiving and storing the digital certificate by using the digital certificate receiver having a display on which the digital certificate is shown; and reading the digital certificate shown on the display by using an digital certificate reader and decoding the digital certificate into the shopping information. Currently available mobile communication devices are utilized as receiving media for digital certificates so as to facilitate commercial activities such as business transactions, reissuing certificates, transfer of ownership and cancellation of order, without risks of being duplicated or embezzled.

### BACKGROUND OF THE INVENTION

1. Field of the Invention

The present invention generally relates to a device and a method for digital certificate distribution, more particularly to facilitate commercial activities through digital certificate distribution such as business transactions, reissuing certificates, transfer of ownership and cancellation of order, without risks of being duplicated or embezzled.

2. Description of the Prior Art

In recent years, the number of netizens has increased intensely due to the rapid growth of personal computers and Internet-related technologies, facilitating Internet-based business. As one of the most common e-commerce activities, on-line shopping or e-shopping provides feasible business transactions not only of material products such as daily necessities but also of certificates of train tickets, concert tickets, coupons, etc.

FIG. 1 shows a conventional method for e-shopping. The method is characterized in that the seller posts the catalog on the website and, after the buyer reviews the website, he/she picks the products that he/she desires to buy and fill in an order form including information of products and buy's identity, as described in Step 13. More particularly, the information of products includes species, quantity, price, etc. The information of buy's identity includes his/her name, billing address, ID number, telephone number, shipping address, method for payment, etc.

As the buyer finishes selecting the products to be purchased, he/she places an order via telecommunication (such as website, email, facsimile and telephone) or post mail so as to inform the seller of the information of products and buy's identity, as described in Step 14.

When the seller receives the information, the seller sends a corresponding certificate via email, facsimile and telephone or post mail to the buyer, as described in Step 15.

Such a certificate is required for the buyer to get the purchased products in return no matter how the certificate is delivered to him/her, as described in Step 16.

For entrance tickets, train tickets, coupons, lottery tickets and tickets for a superstar concert, it is very important to deliver the certificate safely to the buyer so as to get the purchased products in return. For instance, a transactional dispute may occur if the information is intercepted during distribution of the certificate or the certificate is lost but cannot be invalidated and reissued. Moreover, if the buyer somehow loses the certificate or finds that the certificate is duplicated after he/she receives it, he/she requires being able to cancel the transaction as long as it is necessary. Otherwise, such inconvenience and insecurity may hold back the growth of digital commerce.

Therefore, there is a need in providing a device and a method for digital certificate distribution, so as to ensure the distribution of the certificate.

### SUMMARY OF THE INVENTION

Accordingly, it is the primary object of the present invention to provide a method for digital certificate distribution via telecommunication so as to reduce the cost and avoid the risk while shipping a material certificate.

It is a secondary object of the present invention to provide a method for digital certificate distribution with encryption so as to prevent the digital certificate from being duplicated and further embezzled.

It is another object of the present invention to provide a method for digital certificate distribution with digital display as a replacement for paper so as to save resources.

It is still another object of the present invention to provide a device for digital certificate distribution using present mobile communication apparatus for digital certificate distribution, which is easy to use and highly compatible.

It is still another object of the present invention to provide a device for digital certificate distribution so as to speed up the transaction and increase the degree of accuracy in quantity.

In order to achieve the foregoing objects, the present invention provides a device for digital certificate distribution, comprising: at least an digital certificate receiver for receiving and storing at least an digital certificate, a display being provided on the digital certificate receiver for displaying the digital certificate; a digital certificate transmitter for transmitting the digital certificate to the digital certificate receiver by using a telecommunication device; and an digital certificate reader for reading the digital certificate displayed on the display on the digital certificate receiver.

In order to achieve the foregoing objects, the present invention further provides a method for digital certificate distribution, comprising steps of: encoding shopping information into an digital certificate prior to being transmitted by using an digital certificate transmitter, and then the digital certificate being transmitted to an digital certificate receiver by using a telecommunication device; receiving and storing the digital certificate by using the digital certificate receiver having a display on which the digital certificate is shown; and reading the digital certificate shown on the display by using a digital certificate reader and decoding the digital certificate into the shopping information.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic flow chart showing a method for e-shopping in accordance with the prior art;

FIG. 2 is a schematic flow chart showing a method for e-shopping in accordance with one preferred embodiment of the present invention;

FIG. 3 is a schematic diagram showing a digital certificate in accordance with one preferred embodiment of the present invention;

FIG. 4 is a schematic flow chart showing a method for e-shopping in accordance with another embodiment of the present invention; and

FIG. 5 is a schematic flow chart showing a method for cancellation and re-issue of the certificate in accordance with another embodiment of the present invention.

### DETAILED DESCRIPTION OF THE INVENTION

The present invention providing a device and a method for digital certificate distribution can be exemplified by the preferred embodiments as described hereinafter.

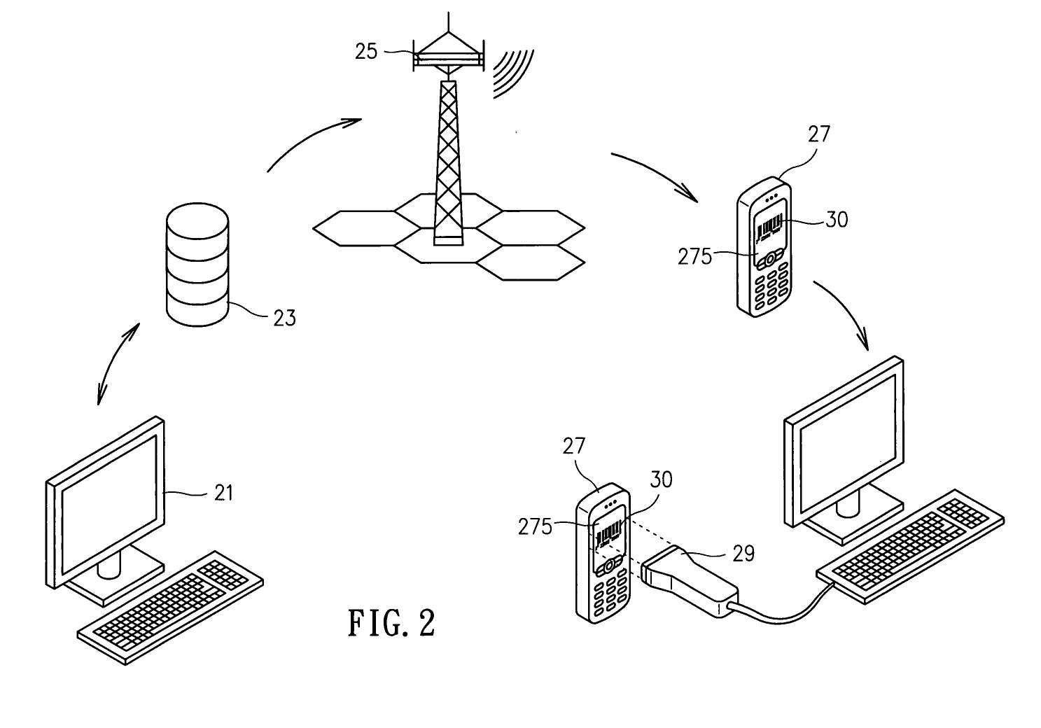

To start with, please refer to FIG. 2, which is a schematic flow chart showing a method for e-shopping in accordance with one preferred embodiment of the present invention. In FIG. 2, a device for digital certificate distribution comprises comprising: a digital certificate transmitter 23; a telecommunication device 25; at least a digital certificate receiver 27; and at least a digital certificate reader 29.

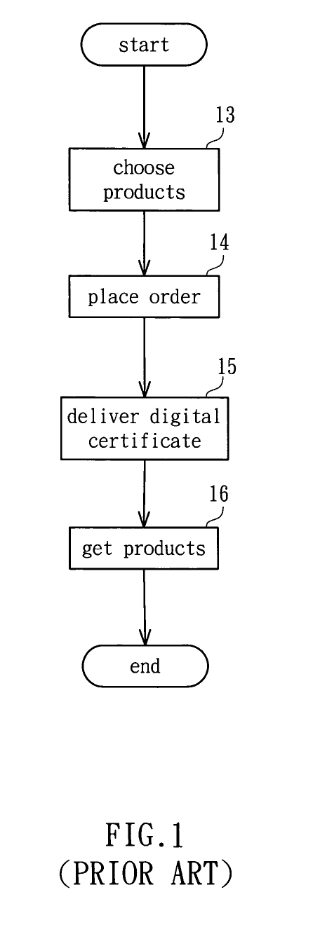

The buyer, as described in Step 13 and Step 14 in the conventional e-shopping method in FIG. 1, picks the products that he/she desires to buy and places an order via telecommunication. Then the seller uses the digital certificate transmitter 23 so as to receive and encode the shopping information of the buyer into a digital certificate 30. The digital certificate transmitter 23 is generally a host server. Taking the currently used e-shopping method for example, the front-end is a net-trading device 21, such as a computer, connected to the catalog on the website via Internet for s-shopping.

After the digital certificate 30 is provided by the digital certificate transmitter 23, the telecommunication device 25 (with GSM, GPRS, CDMA or PHS interface) delivers the digital certificate 30 to the digital certificate receiver 27 such as a mobile phone, a PDA, a personal computer, a portable computer, etc. The digital certificate receiver 27 receives and stores the digital certificate 30, which is to be displayed on a display 275 of the digital certificate receiver 27.

Afterwards, the buyer can get what he/she purchases when he/she brings the digital certificate receiver 27 as well as the digital certificate 30 stored therein to a designated place and let the digital certificate reader 29 directly scanning and reading the digital certificate 30 displayed on a display 275 of the digital certificate receiver 27. The digital certificate reader 29 is preferably a scanner, a code reader or a digital camera.

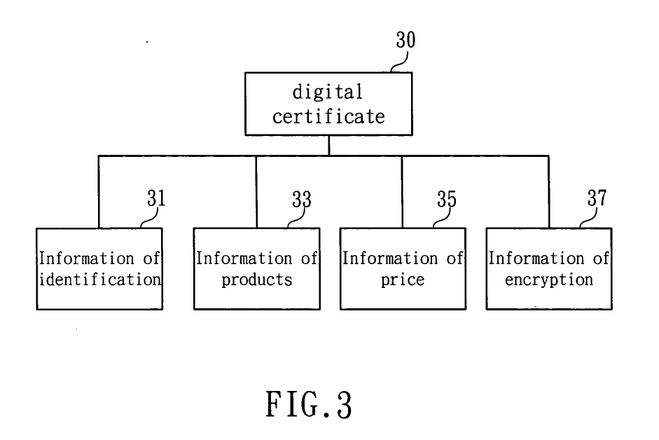

Additionally, please also refer to FIG. 3, which is a schematic diagram showing a digital certificate in accordance with one preferred embodiment of the present invention. As shown in FIG. 3, the digital certificate comprises at least information of identification 31, information of products 33, information of price 35, and information of encryption 37. More particularly, the information of identification 31 includes information of telephone numbers, subscriber's identification numbers, and so forth; the information of products 33 includes information of dates, the number of showings of films (games, or plays) and seats; the information of price 35 includes quantity and unit price of the products; and the information of encryption 37 includes serial number(s) and password(s) of transaction(s).

As long as the buyer and the seller want to complete a business transaction, the buyer delivers shopping information such as the information of identification 31, the information of products 33 and the information of price 35 to the digital certificate transmitter 23 of the seller. Then the digital certificate transmitter 23 encodes and enciphers the shopping information into a digital certificate 30.

The digital certificate 30 is now widely used in applications such as tickets for trains, boats, flights, concerts, games, coupons, lotteries, etc. so as to increase the security and convenience. In order to avoid being embezzled by others, the digital certificate 30 is encoded with encryption such that it can only be received by an assigned digital certificate receiver 27. Moreover, the digital certificate 30 can never be duplicated, delivered, or printed after it has been received by the digital certificate receiver 27.

Owing to the popularity of mobile phones, the digital certificate receiver 27 and the net-trading device 21 of the present invention can be implemented by using a mobile phone. In this manner, not only that plenty of time spent on waiting in line for shopping and waiting for the products to arrive can be saved, but also that the quantity of items of products can be increased. For example, the currently available mobile communication systems such as GSM, GPRS, CDMA, PHS, PDC, TDMA and D-AMPS utilizes a SIM (subscriber's identification module) card for identification such that the digital certificate 30 according to the present invention can be stored in the subscriber's identification module.

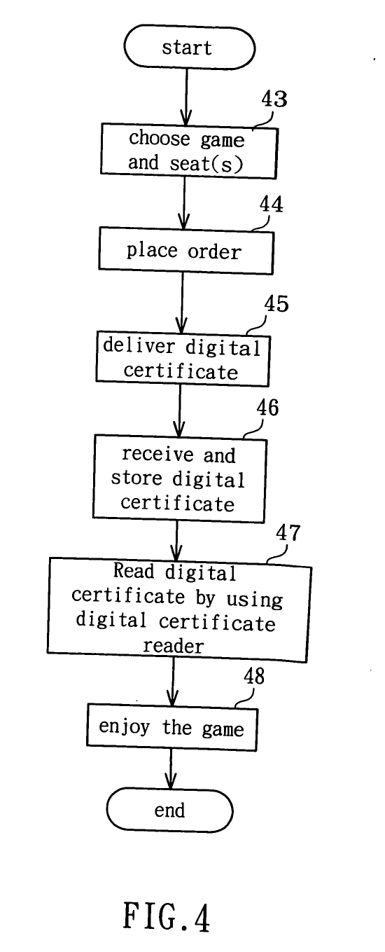

To better understand the present invention, please refer to FIG. 4, which is a schematic flow chart showing a method for e-shopping in accordance with another embodiment of the present invention. As shown in the figure, when a baseball fan wants to buy a ticket via net-trading for a baseball game, for example one game in the World Series at Yankee Stadium, New York, the buyer chooses a game to be held at 20:00, Oct. 26, 2003 and four seats numbered C_{—}1 to C_{—}4 located in Row B in Section A, after reviewing the schedule on the flysheet or on Internet, as described in Step 43.

Afterwards, the buyer places an order via telecommunication using telephone, facsimile or Internet and the seller provides in return an digital certificate comprising: information of products 33 that includes the date on Oct. 26, 2003, the location at Yankee Stadium, the time at 20:00, the seats numbered C_{—}1 to C_{—}4 located in Row B in Section A; information of price 35 that includes quantity of 4 and unit price of 50 dollars; information of identification 31 that includes the buyer's information and the digital certificate receiver 27 implemented by using a mobile phone with an assigned number D. The information as aforementioned is then delivered to the digital certificate transmitter 23 of the seller, as described in Step 44.

As the buyer finishes placing the order, the seller encodes and enciphers the information of identification 31, the information of products 33 and the information of price 35 with the information of encryption 37 into a digital certificate 30. Furthermore, the digital certificate 30 is then delivered by the digital certificate transmitter 23 and the telecommunication device 25 to a mobile phone 27 with an assigned number B, as described in Step 45.

The mobile phone 27 of the buyer receives the digital certificate 30 and stores the digital certificate 30 inside the SIM card of the mobile phone 27, as described in Step 46.

When the buyer arrives at Yankee Stadium by the time the game begins, he/she or anyone else who holds the mobile phone 27 can have the digital certificate 30 scanned by the digital certificate reader 29 installed at the entrance of the stadium, as described in Step 47. The display of the mobile phone 27 shows that the information of the date on Oct. 26, 2003, the location at Yankee Stadium, the time at 20:00, the seats numbered C_{—}1 to C_{—}4 located in Row B in Section A, thereby the buyer and his/her friends entering the stadium and enjoying the game, as described in Step 48.

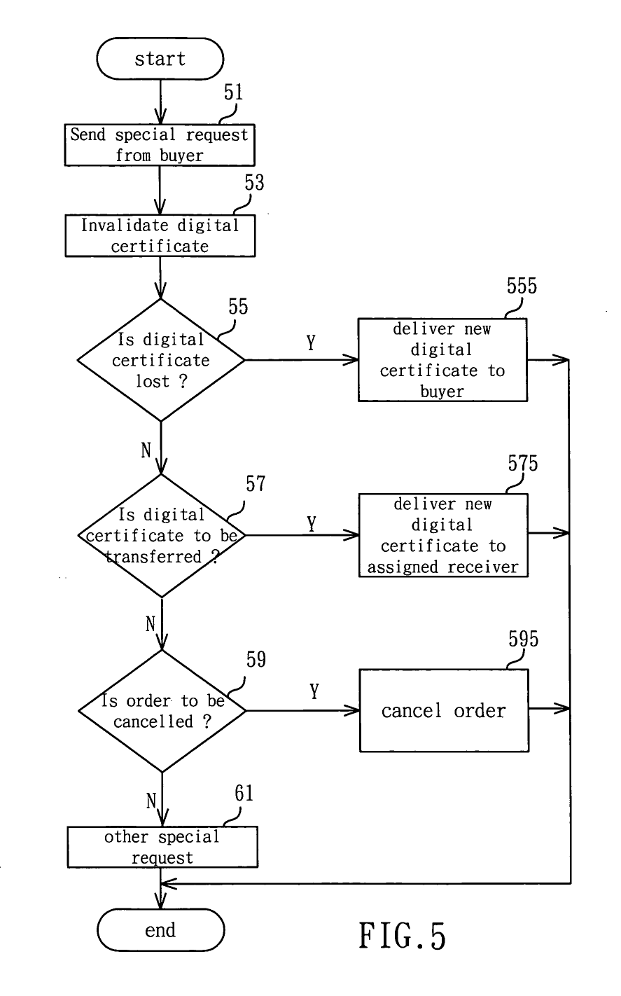

Usually, for popular shows or performances, the time for ticket sale advances the actual show time for months; accordingly, it happens that, during such long period of time, the digital certificate may be lost or that the buyer could not help but decide to transfer the ownership of the certificate to others. Therefore, in the present invention, the method for digital certificate provides conveniences such as reissuing certificates, transfer of ownership and cancellation of order, without risks of being duplicated or embezzled. Please refer to FIG. 5, which is a schematic flow chart showing a method for cancellation and re-issue of the certificate in accordance with another embodiment of the present invention. As shown in the drawing, the buyer sends the seller a notice of a special request for reissuing certificates, transfer of ownership and cancellation of order, as described in Step 51.

As the seller receives the notice, the seller sends a request to the digital certificate reader 29 that the digital certificate 30 has been invalidated, as described in Step 53. Therefore, even though the buyer or anyone else carries the digital certificate receiver that stores the digital certificate 30 to the digital certificate reader 29, the digital certificate reader 29 sends a message of denial and refuses to let the buyer get the products.

On the other hand, the seller reconfirms the request from the buyer and determines if the digital certificate receiver is lost and a new digital certificate has to be re-issued to an assigned location, as described in Step 55. If yes, the process goes to Step 555; otherwise, the process goes to Step 57.

In Step 555, once the digital certificate is confirmed to be lost together with the digital certificate receiver and a new digital certificate has to be re-issued, the sellers delivers the new digital certificate again by using the digital certificate transmitter 23 and the telecommunication device 25 to a newly prepared digital certificate receiver of the buyer. Since the original digital certificate has been cancelled in Step 53, anyone who happens to pick up the missing digital certificate receiver cannot get the ticket(s).

In Step 57, the seller determines if the digital certificate is to be transferred. If yes, the process goes to Step 575; otherwise, the process goes to Step 59.

In Step 575, the digital certificate is determined to be transferred to a third party. Therefore, the seller delivers a new digital certificate again by using the digital certificate transmitter 23 and the telecommunication device 25 to an assigned digital certificate receiver of the third party.

In Step 59, the seller determines if the order is to be cancelled. If yes, the process goes to Step 595; otherwise, the process goes to Step 61.

In Step 595, the order has been determined to be cancelled. The seller cancels the order and returns the payment to the buyer.

In Step 61, the seller determines if there is any buyer's special request other than reissuing certificates, transfer of ownership and cancellation of order. If yes, the seller proceeds with further service according to the buyer's special request.

According to the above discussion, it is apparent that the present invention discloses a device and a method for digital certificate distribution, characterized in that currently available mobile communication devices are utilized as receiving media for digital certificates so as to facilitate commercial activities such as business transactions, reissuing certificates, transfer of ownership and cancellation of order, without risks of being duplicated or embezzled.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A device for digital certificate distribution, comprising:
at least a digital certificate receiver for receiving and storing at least a digital certificate, a display being provided on said digital certificate receiver for displaying said digital certificate;
a digital certificate transmitter for transmitting said digital certificate to said digital certificate receiver by using a telecommunication device; and
a digital certificate reader for directly scanning and reading said digital certificate displayed on said display of said digital certificate receiver.

2. The device for digital certificate distribution as claimed in claim 1, wherein said digital certificate is in one form selected from a group consisting of multi-dimensional barcode, one-dimensional barcode and combination thereof.

3. The device for digital certificate distribution as claimed in claim 1, wherein said digital certificate reader is selected from a group consisting of a scanner, a barcode reader, a digital camera, and combination thereof.

4. The device for digital certificate distribution as claimed in claim 1, wherein said digital certificate receiver is selected from a group consisting of a mobile phone, a personal digital assistant (PDA), a personal computer, a portable computer, a stock information pager and combination thereof.

5. The device for digital certificate distribution as claimed in claim 4, wherein said digital certificate is stored in a subscriber's identification module (SIM) card inside said mobile phone.

6. The device for digital certificate distribution as claimed in claim 1, wherein said digital certificate is generated using encoding with encryption to prevent from any risks of being duplicated, delivered and printed.

7. The device for digital certificate distribution as claimed in claim 1, wherein said digital certificate comprises at least one selected from a group consisting of information of identification, information of products, information of price, information of encryption and combination thereof.

8. The method for digital certificate distribution as claimed in claim 1, wherein said digital certificate transmitter is a server at a workstation.

9. The device for digital certificate distribution as claimed in claim 1, wherein said digital certificate is selected from a group consisting of tickets for buses, trains, boats, flights, concerts, games, coupons, lotteries and combination thereof.

10. The device for digital certificate distribution as claimed in claim 1, wherein said telecommunication is supported by a system selected from a group consisting of GSM, GPRS, CDMA, PHS and combination thereof.

11. A method for digital certificate distribution, comprising steps of:
encoding shopping information into a digital certificate prior to being transmitted by using a digital certificate transmitter, and said digital certificate being transmitted to a digital certificate receiver by using a telecommunication device;
receiving and storing said digital certificate by using said digital certificate receiver having a display, on which said digital certificate is shown; and
reading said digital certificate shown on said display by using a digital certificate reader and decoding said digital certificate into said shopping information.

12. The method for digital certificate distribution as claimed in claim 11, further comprising steps of:
sending a request from a buyer to a seller;
canceling said digital certification by said seller; and
determining said request from said buyer and selecting at least a step selected from a group consisting of delivering a new digital certificate to an assigned digital certificate receiver of said buyer, cancellation of order, changing transaction products and combination thereof.

13. The method for digital certificate distribution as claimed in claim 12, wherein said request is selected from a group consisting of re-issuing an digital certificate, transferring said digital certificate to a third party, changing content of said digital certificate, cancellation of order and combination thereof.

14. The method for digital certificate distribution as claimed in claim 11, further comprising:
buying a net-trading device and selecting products; and
sending shopping information to a digital certificate receiver of a seller.

15. The method for digital certificate distribution as claimed in claim 11, wherein said digital certificate is generated using encoding with encryption to prevent from any risks of being duplicated, delivered and printed.

16. The method for digital certificate distribution as claimed in claim 11, wherein said digital certificate receiver is selected from a group consisting of a mobile phone, a personal digital assistant (PDA), a personal computer, a portable computer, a stock information pager and combination thereof.

17. The method for digital certificate distribution as claimed in claim 16, wherein said digital certificate is stored in a subscriber's identification module (SIM) card inside said mobile phone.

18. The method for digital certificate distribution as claimed in claim 11, wherein said digital certificate is in one form selected from a group consisting of multi-dimensional barcode, one-dimensional barcode and combination thereof.

19. The method for digital certificate distribution as claimed in claim 11, wherein said digital certificate reader is selected from a group consisting of a scanner, a barcode reader, a digital camera, and combination thereof.

20. The method for digital certificate distribution as claimed in claim 11, wherein said digital certificate comprises at least one selected from a group consisting of information of identification, information of products, information of price, information of encryption and combination thereof.

21. The method for digital certificate distribution as claimed in claim 11, wherein said digital certificate is selected from a group consisting of tickets for buses, trains, boats, flights, concerts, games, coupons, lotteries and combination thereof.

22. The method for digital certificate distribution as claimed in claim 11, wherein said telecommunication is supported by a system selected from a group consisting of GSM, GPRS, CDMA, PHS and combination thereof.
